(19) United States
(12) Patent Application Publication
(10) Pub. No.: US 2025/0314849 A1
(43) Pub. Date: Oct. 9, 2025

(54) OPTICAL APPARATUS

(71) Applicant: CANON KABUSHIKI KAISHA, Tokyo (JP)

(72) Inventors: TOSHIHIRO OGAWA, Tokyo (JP); TORU ISHIMASA, Kanagawa (JP); YOSHIKAZU WATANABE, Chiba (JP)

(21) Appl. No.: 19/063,917

(22) Filed: Feb. 26, 2025

(30) Foreign Application Priority Data
Apr. 8, 2024 (JP) 2024-062254

(51) Int. Cl. G02B 7/02; G02B 7/14; G03B 5/00; G03B 13/34

(52) U.S. Cl. CPC G02B 7/022; G02B 7/14; G03B 5/00; G03B 13/34; G03B 2205/0023

(57) ABSTRACT

An optical apparatus includes a substrate having a first notch portion, a lens mount, a conductive member, and a cover member having an opening and a second notch portion and fixed to the lens mount. The conductive member is disposed between the first notch portion and the second notch portion, is exposed from the opening toward an imaging surface side, and overlaps the substrate on a plane parallel to an imaging surface.

### BACKGROUND

### Technical Field

The disclosure relates to an optical apparatus.

### Description of Related Art

In large-aperture zoom lenses, in order to avoid interference with a zoom unit retracted toward the imaging surface side, a part of a cover member that is fixed to a lens mount and hides a mounted substrate may be notched. In a case where the zoom unit is located at a position closest to an object, a part of the mounted substrate may be exposed from the notch portion of the cover member. Accordingly, a structure that hides the mounted substrate using a member other than the cover member has been proposed.

Japanese Patent Laid-Open No. 2010-164872 discloses an interchangeable lens that includes an internal hood placed between the mounted substrate and the lens mount. Japanese Patent Laid-Open No. 2016-009141 discloses an interchangeable lens having a reduced overall length in which a bridge portion and the mounted part of the mounted substrate overlap each other in the optical axis direction.

In a case where the mounted substrate shifts toward the object side as disclosed in Japanese Patent Laid-Open No. 2010-164872, it becomes difficult to reduce the overall length. In the structure disclosed in Japanese Patent Laid-Open No. 2016-009141, electrical parts and connectors cannot be placed around the bridge portion, and thus this structure may restrict the mountable area of the mounted substrate.

### SUMMARY

An optical apparatus according to one aspect of the disclosure includes a substrate having a first notch portion, a lens mount, a conductive member, and a cover member having an opening and a second notch portion and fixed to the lens mount. The conductive member is disposed between the first notch portion and the second notch portion, is exposed from the opening toward an imaging surface side, and overlaps the substrate on a plane parallel to an imaging surface.

Further features of various embodiments of the disclosure will become apparent from the following description of embodiments with reference to the attached drawings.

### BRIEF DESCRIPTION OF THE DRAWINGS

FIGS. 1A and 1B are perspective views of a camera system according to one embodiment of the present disclosure.

FIG. 2 is a block diagram illustrating the configuration of an interchangeable lens and a camera body.

FIG. 3 is a sectional view of the interchangeable lens at a wide-angle end.

FIG. 4 is a sectional view of the interchangeable lens at a telephoto end.

FIG. 5 is a sectional view of the interchangeable lens at a retracted end.

FIGS. 6A and 6B are rear perspective views of the interchangeable lens.

FIG. 7 is an exploded perspective view of the interchangeable lens.

FIG. 8 is a rear perspective view of a rear group unit at the retracted end.

FIG. 9 is a rear perspective view of the rear group unit at the telephoto end.

FIG. 10 is an exploded perspective view of the components.

FIGS. 11A and 11B are perspective views of the components.

FIG. 12 is a rear view of the components.

FIG. 13 is a sectional view along a line S1-S1 in FIG. 12.

### DETAILED DESCRIPTION

Referring now to the accompanying drawings, a detailed description will be given of embodiments according to the disclosure. Corresponding elements in respective figures will be designated by the same reference numerals, and a duplicate description thereof will be omitted.

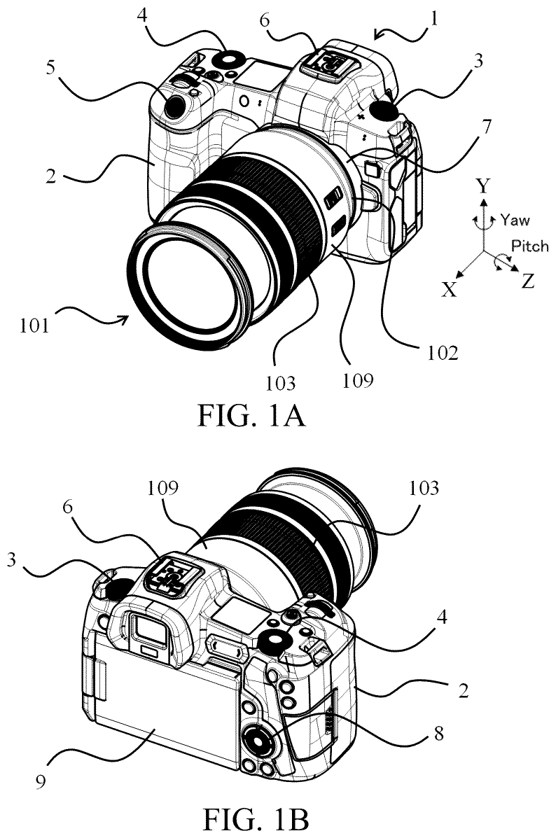

FIGS. 1A and 1B are perspective views of a camera system according to one embodiment of the present disclosure. FIG. 1A is a perspective view of the camera system viewed from the front side (object side) and FIG. 1B is a perspective view of the camera system viewed from the back side (imaging surface side). The camera system includes an interchangeable lens (optical apparatus) 101 and a digital camera (hereinafter referred to as a camera body) 1 attachable to and detachable from the interchangeable lens 101. In this embodiment, as illustrated in FIG. 1A, the direction in which the optical axis of the imaging optical system housed in the interchangeable lens 101 extends is set to an X-axis direction (optical axis direction), and the directions orthogonal to the X-axis direction are set to a Z-axis direction (horizontal direction) and a Y-axis direction (vertical direction). The Z-axis direction and the Y-axis direction are collectively referred to as a Z/Y-axis direction hereinafter. A rotation direction around the Z-axis will be referred to as a pitch direction, and a rotation direction around the Y-axis will be referred to as a yaw direction. The pitch direction and the yaw direction (collectively referred to as a pitch/yaw direction hereinafter) are rotation directions around two axes, the Z-axis and the Y-axis, which are mutually orthogonal. In this embodiment, an interchangeable lens is described as an example of an optical apparatus, but the present disclosure is also applicable to other optical apparatuses such as a lens-integrated type camera.

A grip portion 2 for a user to hold the camera body 1 with his/her hand is provided on the left side when the camera is viewed from the front (right side when viewed from the back). A power operation unit 3 is provided on the top surface of the camera body 1. In a case where the user turns on the power operation unit 3 while the camera body 1 is in a power-off state, electrification is started and the camera body 1 is turned on, and a computer program such as processing for detecting the origin of the focus unit is executed, and the camera body 1 is in an imaging standby state. In a case where the user turns off the power operation unit 3 while the camera body 1 is in a power-on state, the camera body 1 becomes powered off.

A mode dial 4, a release button 5, and an accessory shoe 6 are provided on the top surface of the camera body 1. The user can switch an imaging mode by rotating the mode dial 4. The imaging modes include a manual still image capturing mode in which the user can arbitrarily set an imaging condition such as a shutter speed and an F-number (aperture value), an automatic still image capturing mode in which a proper exposure is automatically obtained, and a moving image capturing mode for capturing a moving image. The user can instruct an imaging preparation operation such as autofocus (AF) and auto-exposure (AE) control by half-pressing the release button 5, and can instruct imaging by fully pressing the release button 5. An accessory (camera accessory) such as an external flash or other lighting or light-emitting apparatus is detachably attached to the accessory shoe 6.

The interchangeable lens 101 includes a lens mount 102 that can be mechanically and electrically connected to a camera mount 7 provided on the camera body 1. The lens mount 102 and the camera mount 7, each of which has a circular ring shape, are made of a metal material and are detachable via a bayonet connection (not illustrated). There are no restrictions on the combination of the interchangeable lens 101 and the camera body 1 as long as the camera system adopts a common mount shape.

The interchangeable lens 101 includes an imaging optical system that forms an object image using light from an object. The outer circumference of the interchangeable lens 101 is provided with a zoom operation ring (operation member) 103 that can be rotated around the optical axis by a user operation. In a case where the zoom operation ring 103 is rotated by the user, the zoom unit constituting the imaging optical system moves to a predetermined use position corresponding to the angle of the zoom operation ring 103 within a range from the wide-angle end on the short focal side of the zoom to the telephoto end on the long focal side of the zoom. Thereby, the user can perform imaging at a desired angle of view. In this embodiment, a retractable end where imaging is further restricted is provided at an end where the zoom operation ring 103 is rotated from the telephoto end to the wide-angle end. The retractable end is a position where the interchangeable lens 101 is most retracted.

As illustrated in FIG. 1B, a rear operation unit 8 and a display unit 9 are provided on the rear surface of the camera body 1. The rear operation unit 8 includes a plurality of buttons and dials to which various functions are assigned. In a case where the camera body 1 is powered on and a still image or moving image capturing mode is set, a through-image (live-view image) of an object image captured by an image sensor, which will be described later, is displayed on the display unit 9. The display unit 9 also displays imaging parameters indicating imaging conditions such as a shutter speed and an F-number, and the user can change the settings of the imaging parameters by operating the rear operation unit 8 while viewing the display unit 9. The rear operation unit 8 includes a playback button for instructing playback of a recorded captured image, and the captured image is played back and displayed on the display unit 9 in a case where the user operates the playback button. The display unit 9 may be of a touch panel type and have the same functions as the rear operation unit 8.

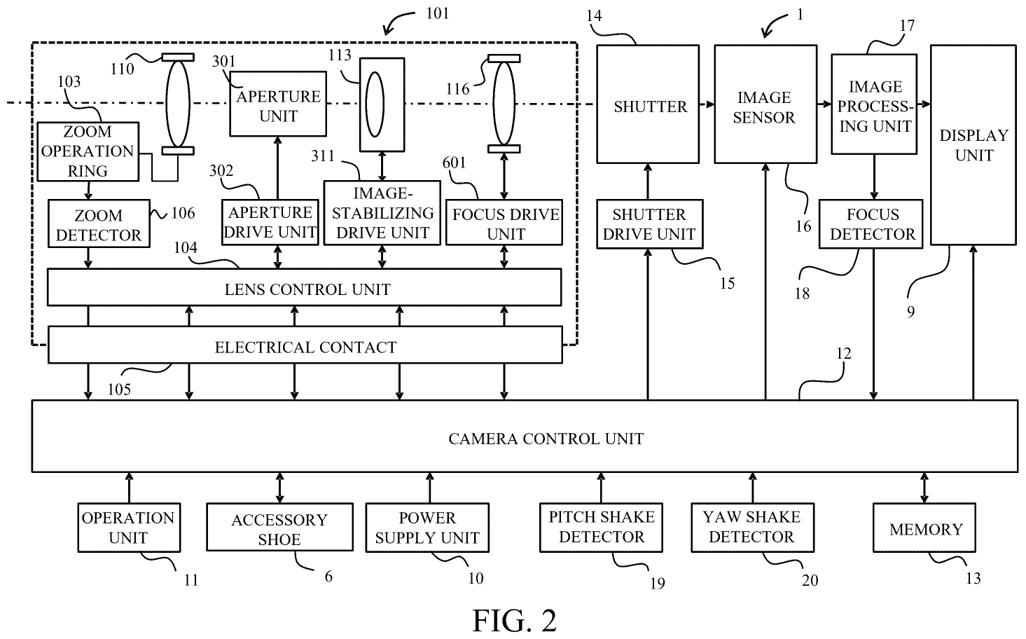

FIG. 2 is a block diagram illustrating the electrical and optical configurations of the interchangeable lens 101 and the camera body 1. The camera body 1 includes a power supply unit 10 that supplies power to the camera body 1 and the interchangeable lens 101, and an operation unit 11 including the power operation unit 3, the mode dial 4, the release button 5, the rear operation unit 8, and the touch panel function of the display unit 9. In this embodiment, the camera body 1 and interchangeable lens 101 as an entire system is controlled by the cooperation of a camera control unit 12 provided in the camera body 1 and a lens control unit (substrate) 104 provided in the interchangeable lens 101.

The camera control unit 12 reads out and executes a computer program stored in a memory 13. At that time, the camera control unit 12 communicates various control signals, data, etc. with the lens control unit 104 via a communication terminal of an electrical contact 105 provided to the lens mount 102. The electrical contact 105 includes a power terminal that supplies power from the power supply unit 10 to the interchangeable lens 101.

The imaging optical system in the interchangeable lens 101 includes a zoom unit 110 connected to the zoom operation ring 103 and movable in the optical axis direction to change an angle of view, and an aperture (stop) unit 301 configured to adjust a light amount. The imaging optical system further includes a lens image-stabilizing unit 113 that includes a shift lens as an image stabilizing element configured to reduce image blur by moving (shifting) in the Z/Y axis direction orthogonal to the optical axis. The imaging optical system further includes a focus unit 116 that includes a focus lens movable in the optical axis direction for focusing. The interchangeable lens 101 includes an aperture drive unit 302 configured to drive the aperture unit 301, an image-stabilizing drive unit 311 configured to move the lens image-stabilizing unit 113, and a focus drive unit 601 configured to move the focus unit 116.

The camera body 1 includes a shutter unit 14, a shutter drive unit 15, an image sensor 16, an image processing unit 17, and a camera control unit 12. The shutter unit 14 controls the light amount exposed to the image sensor 16. The image sensor 16 photoelectrically converts an object image formed by the imaging optical system and outputs an imaging signal. The image processing unit 17 performs various image processing on the imaging signal and then generates an image signal. The display unit 9 displays the image signal (through-image) output from the image processing unit 17, displays the imaging parameters as described above, and plays back and displays the captured image recorded in the memory 13 or a recording medium (not illustrated).

The camera control unit 12 controls the focus drive unit 601 according to the imaging preparation operation (such as half-pressing the release button 5) in the operation unit 11. For example, in a case where an AF operation is instructed, the focus detector 18 determines a focus state of the object image formed by the image sensor 16 based on the image signal generated by the image processing unit 17, generates a focus signal, and transmits it to the camera control unit 12. The focus drive unit 601 also transmits information regarding the current position of the focus unit 116 to the camera control unit 12. The camera control unit 12 compares the focus state of the object image and the current position of the focus unit 116, calculates a focus driving amount from a shift amount, and transmits it to the lens control unit 104. The lens control unit 104 moves the focus unit 116 to a target position in the optical axis direction via the focus drive unit 601, and corrects the focus shift of the object image.

The focus drive unit 601 includes a focus motor that functions as an actuator, and a photo-interrupter configured to detect the origin position of the focus unit 116. In general, a stepping motor, which is a type of actuator, is often used as the focus motor. A DC motor with an encoder, an ultrasonic motor, a servo motor, or the like may also be used as the focus motor. The photo-interrupter directly receives light emitted from a light emitter using a light receiver, but instead of this configuration, a photo-reflector that receives reflected light from a reflective surface, or a brush that contacts a conductive pattern and electrically detects a signal may be used as a detector.

The camera control unit 12 controls the driving of the aperture unit 301 and the shutter unit 14 via the aperture drive unit 302 and the shutter drive unit 15 according to the setting values of the F-number and shutter speed received from the operation unit 11. For example, in a case where an AE control operation is instructed, the camera control unit 12 receives a luminance signal generated by the image processing unit 17 and performs a photometry calculation. Based on the photometry calculation result, the camera control unit 12 controls the aperture drive unit 302 according to an imaging instruction operation (such as full pressing of the release button 5) on the operation unit 11. The camera control unit 12 controls the driving of the shutter unit 14 via the shutter drive unit 15 and performs exposure processing using the image sensor 16.

The camera body 1 includes a pitch shake detector 19 and a yaw shake detector 20 as a shake detector configured to detect image shake caused by a user's hand shake or the like. The pitch shake detector 19 and the yaw shake detector 20 respectively use an angular velocity sensor (vibration gyro) and an angular acceleration sensor to detect image shake in the pitch direction (rotation direction around the Z-axis) and the yaw direction (rotation direction around the Y-axis) and output a shake signal.

The camera control unit 12 calculates the shift position of the lens image-stabilizing unit 113 in the Y-axis direction using the shake signal from the pitch shake detector 19. Similarly, the camera control unit 12 calculates the shift position of the lens image-stabilizing unit 113 in the Z-axis direction using the shake signal from the yaw shake detector 20. The camera control unit 12 then moves the lens image-stabilizing unit 113 to a target position in the Z/Y-axis direction via the image-stabilizing drive unit 311 according to the calculated shift position in the pitch/yaw direction, thereby reducing image shake during exposure and during display of a through image.

The interchangeable lens 101 includes a zoom operation ring 103 for changing an angle of view of the imaging optical system, and a zoom detector 106 for detecting an angle of the zoom operation ring 103. The zoom detector 106 detects the angle of the zoom operation ring 103 operated by the user as an absolute value, and uses, for example, a resistive linear potentiometer. Information on the angle of view detected by the zoom detector 106 is transmitted to the lens control unit 104 and reflected in various controls by the camera control unit 12 described above. Part of the various information is recorded in the memory 13 or a recording medium (not illustrated) together with the captured image.

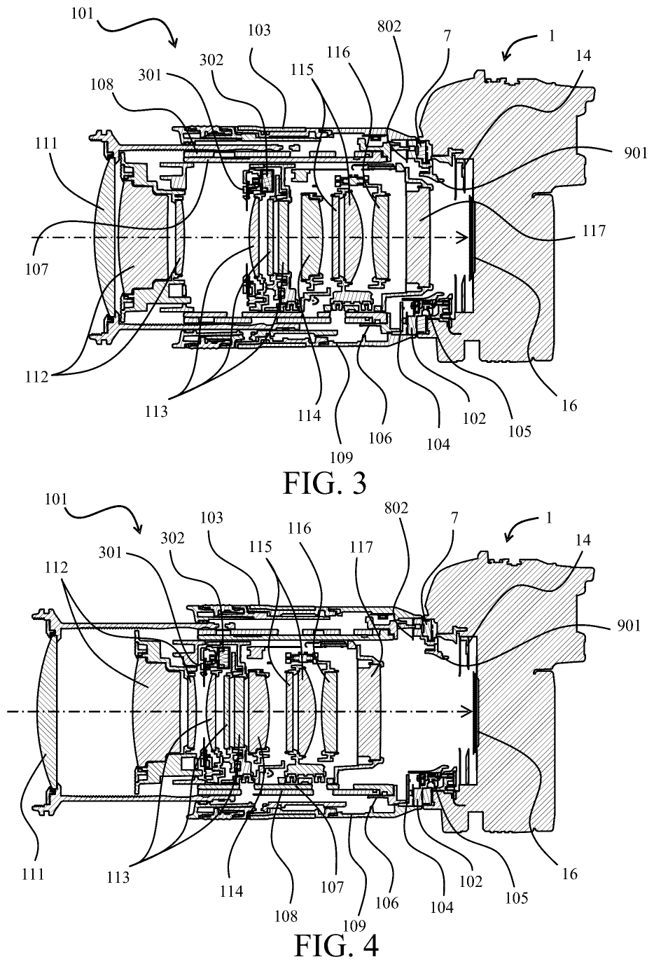

Referring now to FIGS. 3 to 5, a description will be given of the positional relationship of the main components of the interchangeable lens 101. FIGS. 3 to 5 are sectional views on an XY plane including the optical axis of the interchangeable lens at the wide-angle end, the telephoto end, and the retracted end, respectively. A centerline illustrated in each figure approximately coincides with the optical axis determined by the imaging optical system, and therefore is synonymous with the optical axis hereinafter.

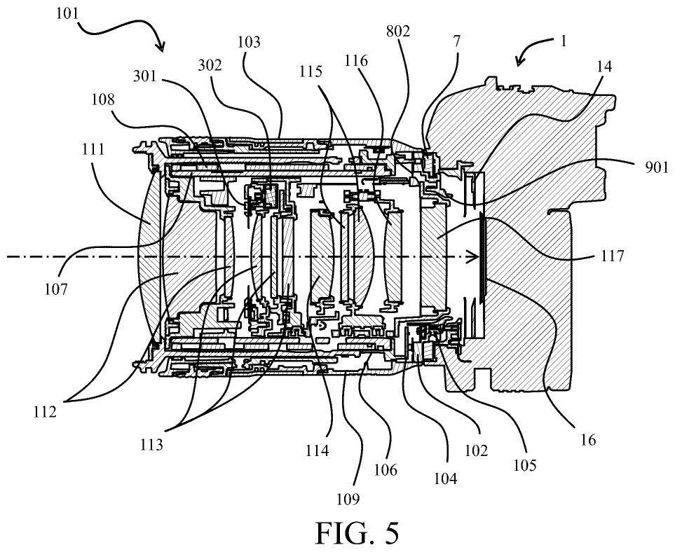

FIGS. 3 and 4 illustrate a state in which the imaging optical system of the interchangeable lens 101 is located at an imageable position (a state in which imaging is not restricted). FIG. 5 illustrates a housed state in which the imaging optical system of the interchangeable lens 101 is located at a retracted position (housed position) (a state in which imaging is restricted). The state in which imaging is not restricted means that the functions of the camera system including the camera body 1 and the interchangeable lens 101 can always operate normally. The state in which imaging is restricted means that some of the functions of the camera system including the camera body 1 and interchangeable lens 101 do not operate normally. For example, in a case where the imaging optical system is located at the retracted position, imaging itself (for example, pressing the shutter to image an object) is possible, but the captured image may be out of focus or may be partially or entirely blurred.

The retracted end in FIG. 5 is located beyond the wide-angle end in FIG. 3, and by rotating the zoom operation ring 103 in one direction, the zoom position moves from the retracted end in FIG. 5 to the wide-angle end in FIG. 3, and from the wide-angle end in FIG. 3 to the telephoto end in FIG. 4, in this order.

As illustrated in FIGS. 3 and 4, this embodiment employs a seven-unit configuration as an example imaging optical system. The zoom unit 110 includes a first zoom unit 111, a second zoom unit 112, the aperture unit 301, a lens image-stabilizing unit 113 functioning as a third zoom unit, a fourth zoom unit 114, a fifth zoom unit 115, a focus unit 116 functioning as a sixth zoom unit, and a seventh zoom unit 117. Each of the lens units included in the zoom unit 110 moves to different predetermined use positions between the wide-angle end and the telephoto end to form an object image on the plane (imaging surface) of the image sensor 16. This disclosure does not limit the configuration of the imaging optical system, and for example, the lens image-stabilizing unit 113 and the focus unit 116 may function as other zoom units. Some of the lens units may not be movable and may be fixed.

A linear guide barrel 107 and a cam barrel 108 are manufactured by cutting a metal material, and in particular, the linear guide barrel 107 is a fixed part that is fixed to the lens mount 102 via a fixed barrel (not illustrated). Bayonet claws (not illustrated) are disposed at regular intervals on the outer circumference surface of the linear guide barrel 107. A circumferential groove (not illustrated) is provided on the inner circumference surface of the cam barrel 108. The cam barrel 108 is connected to the zoom operation ring 103. In a case where the user rotates the zoom operation ring 103, the engagement between the bayonet claws and the circumferential groove restricts the cam barrel 108 from moving in the optical axis direction and causes it to rotate about the optical axis.

The linear guide barrel 107 has linear guide grooves formed at regular intervals and configured to restrict the zoom unit 110 from moving in the rotational direction and to guide the linear movement of the zoom unit 110 in the optical axis direction. The cam barrel 108 has cam grooves having different angles in the rotational direction and formed at regular intervals for the zoom unit 110. The zoom unit 110 includes a plurality of rollers, each of which is engaged with a corresponding linear guide groove and cam groove. In a case where the user rotates the zoom operation ring 103, the cam barrel 108 rotates, and the rollers move the zoom unit 110 forward and backward in the optical axis direction while restricting movement in the rotational direction by engaging the linear guide groove with the cam groove.

The interchangeable lens 101 has a retractable mechanism, and the zoom unit 110 can be further retracted toward the rear side during non-imaging. Thereby, the overall length of the interchangeable lens 101 can be reduced, and the portability of the interchangeable lens 101 and the camera body 1 can be improved. As will be described in more detail later, in FIG. 5, the seventh zoom unit 117 retracts toward the imaging surface side, penetrates through the lens control unit 104 and the lens mount 102, and moves to a position where it overlaps a cover member 901 that constitutes the exterior of the rear side of the interchangeable lens 101.

At the wide-angle end in FIG. 3, a distance between the second zoom unit 112 and the lens image-stabilizing unit 113 increases, and at the telephoto end in FIG. 4, a distance between the first zoom unit 111 and the second zoom unit 112 increases. Thus, the retractable mechanism reduces the distance between them, moves them to the retracted position where they are close to each other, and reduces the overall length in the optical axis direction. As illustrated in FIG. 5, at the retracted end during non-imaging, the zoom unit 110 moves to the retracted position so that its zoom units are close to each other. For example, in a case where the user rotates the zoom operation ring 103 to the wide-angle end from the state in FIG. 5, the zoom unit 110 extends to the front side and moves to a predetermined use position, thereby reaching the imageable state in FIG. 3.

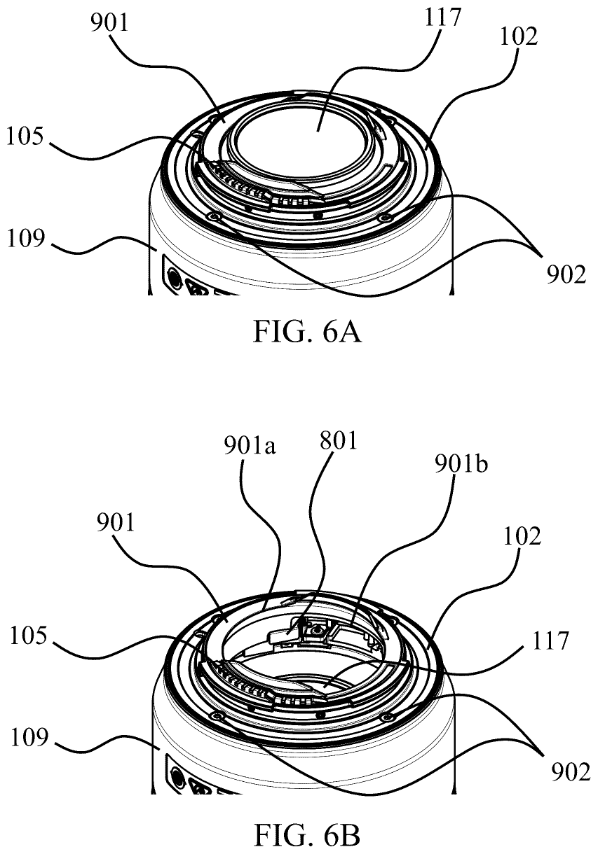

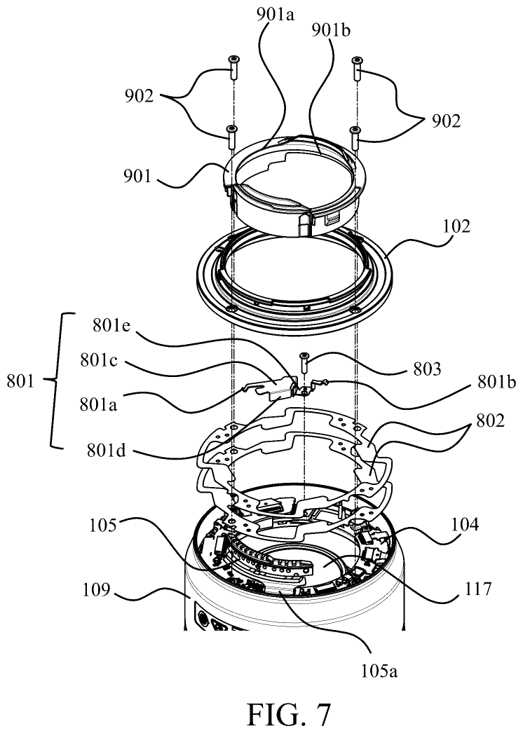

Referring now to FIGS. 6A, 6B and 7, a description will be given of the interior of the rear side of the interchangeable lens 101.

FIGS. 6A and 6B are rear perspective views of the interchangeable lens. FIG. 6A illustrates the retracted end where the seventh zoom unit 117 is most retracted toward the imaging surface side, and corresponds to FIG. 5. FIG. 6B illustrates the telephoto end, and corresponds to FIG. 4. FIG. 7 is an exploded perspective view illustrating the partially exploded components at the telephoto end of FIG. 6B.

The exterior of the rear side of the interchangeable lens 101 mainly includes a cover member 901, the electrical contact 105, the lens mount 102, and an exterior barrel (barrel member) 109. An opening 901a is formed in the cover member 901, and at the retracted end in FIG. 6A, the seventh zoom unit 117 protrudes from the inner circumference of the opening 901a and is exposed to the exterior. At the telephoto end in FIG. 6B, the seventh zoom unit 117 is extended toward the front side, so that an (electrically) conductive member 801, described later, is exposed to the interior from the inner circumference side of the opening 901a.

Generally, at the telephoto end, in an attempt to hide the lens control unit 104 using the cover member 901, a large retracted amount of the seventh zoom unit 117 toward the imaging surface side causes the seventh zoom unit 117 to interfere with the cover member 901 as at the retracted end on the opposite side. Accordingly, this embodiment forms a second notch portion 901b in the cover member 901.

In assembling the cover member 901, it is inserted into the lens mount 102 from the imaging surface side and fixed to it. The hiding shape of the cover member 901 can only be positioned inside the inner diameter of the lens mount 102, and it is difficult to suppress exposure of the lens control unit 104 with the cover member 901 alone. Conventionally, a structure has been proposed in which the lens control unit 104 is concealed using an interior member other than the cover member 901, but completely concealing the lens control unit 104 and the conductive member 801 suppresses the miniaturization of the interchangeable lens 101.

While the interchangeable lens 101 is attached to the camera body 1, the user cannot see the rear surface of the interchangeable lens 101 as the interior. Accordingly, instead of pursuing the quality of the interior, this embodiment adopts a structure in which miniaturization is prioritized while securing reliability. More specifically, a part of the conductive member 801 is exposed to the interior, and a part of the lens control unit 104 is covered and concealed by the conductive member 801.

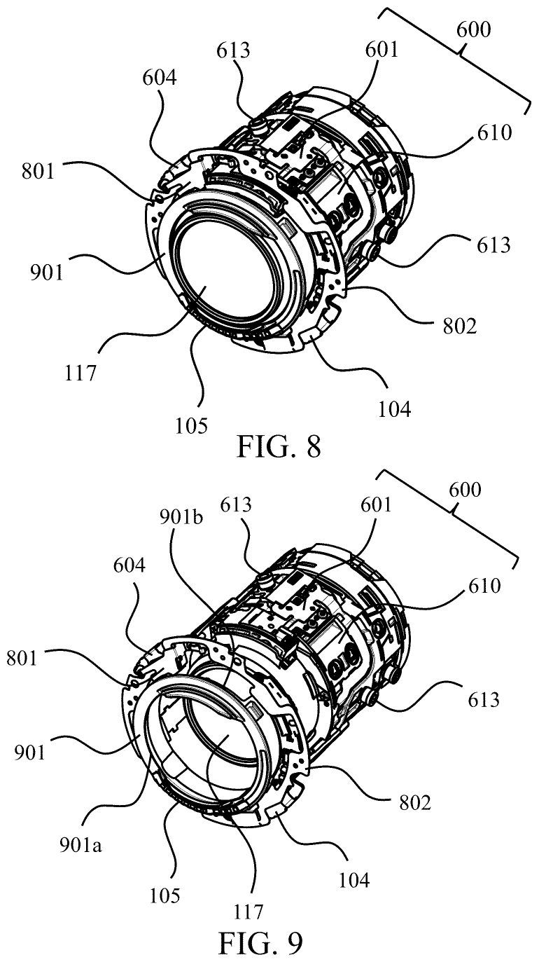

A description will now be given of the rear group unit 600 with reference to FIGS. 8 and 9. FIGS. 8 and 9 are rear perspective views of the rear group unit 600 at the retracted end and the telephoto end, respectively. FIGS. 8 and 9 partially omit the components, and are viewed from a different direction from that of the rear perspective views illustrated in FIGS. 6A, 6B, and 7.

The rear group unit 600 includes a movable barrel 610. The fourth zoom unit 114, the fifth zoom unit 115, and the focus unit 116 are housed in the movable barrel 610. The seventh zoom unit 117 is fixed to the movable barrel 610. The focus drive unit 601 including a focus motor is disposed in the movable barrel 610. A flexible printed circuit board (FPC) 604 is connected to the lens control unit 104 and supplies power to the focus motor. Three movable rollers 613 are provided at regular intervals on the outer circumferential surface of the movable barrel 610. As described above, the three movable rollers 613 are engaged with the corresponding linear guide grooves and cam grooves. For example, during zooming from the wide-angle end to the telephoto end, the cam barrel 108 rotates, and the movable barrel 610 moves linearly in the optical axis direction together with the components such as the fourth zoom unit 114 and the focus unit 116.

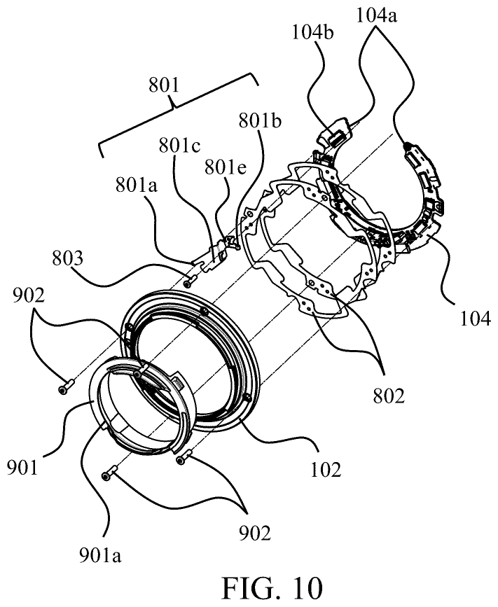

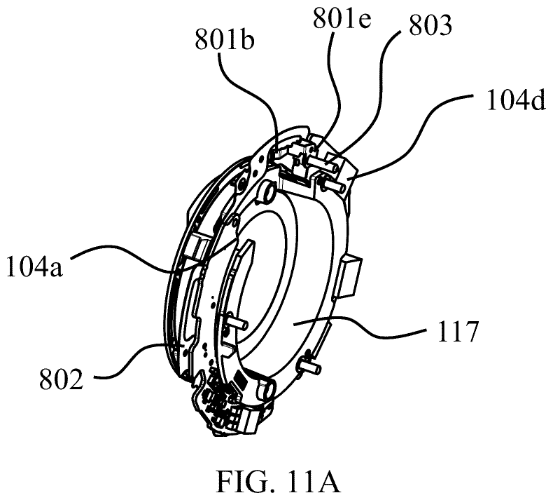

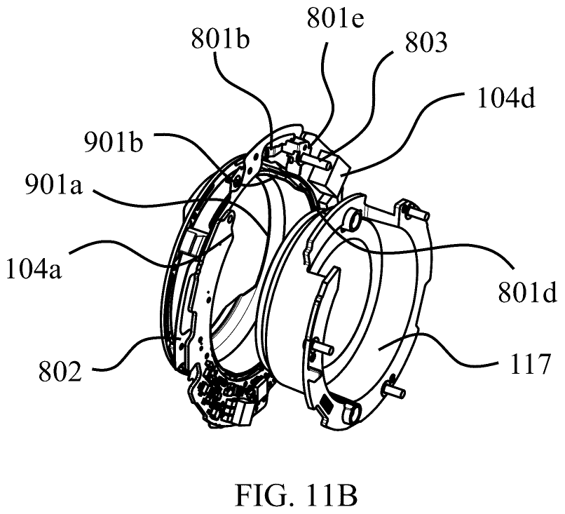

A description will now be given of the lens control unit 104 with reference to FIGS. 7 to 11B. FIG. 10 is an exploded perspective view of the components, omitting some components, and viewed from the same direction as that of the rear perspective views of FIGS. 8 and 9. FIGS. 11A and 11B are perspective views of the components, omitting some components, and viewed from a different direction than that of the front perspective view of FIG. 1A. FIGS. 11A and 11B are perspective views of the components at the retracted end and the telephoto end, respectively.

The lens control unit 104 includes a main plane parallel to the imaging surface, and is the main mounted substrate for controlling the image-stabilizing drive unit 311, the aperture drive unit 302, the focus drive unit 601, etc. The lens control unit 104 has a ground that serves as a reference potential point, and can make the reference potentials of the interchangeable lens 101 and the camera body 1 equal.

A microcomputer equipped with basic control functions, drive ICs for various actuators, connectors for connecting the FPC, etc. are mounted by soldering on the plane of the lens control unit 104. The connector 104b is one of a plurality of connectors mounted on the lens control unit 104, and is a connector with the FPC 604 that supplies power to the focus motor. The height of the connector 104b is about 1.0 mm, and this is approximately similar to the height of another connector. The plurality of mounted components may be mounted only on one side (the object side or the imaging surface side) of the lens control unit 104 instead of on both sides.

The outer shape of the lens control unit 104 is an arc shape having an inner diameter and an outer diameter, each of which has the same center as the optical axis, and is divided by a first notch portion 104a and has a distal end. The interchangeable lens 101 according to this embodiment is a large-diameter zoom lens that employs a rear focus type, and as illustrated in FIG. 8, at the retracted end, the focus drive unit 601, which is a part of the rear group unit 600, and the seventh zoom unit 117 overlap the lens control unit 104 in the optical axis direction. The first notch portion 104a is provided to avoid interference with these components. Since the first notch portion 104a completely divides the lens control unit 104, the material selection can be improved more efficiently than that of the lens control unit 104 in an annular ring shape with the entire circumference connected. The term “arc shape” refers to a shape that can be distinguished as an arc from the exterior, and includes an approximate arc shape.

The electrical contact 105 having an arc shape is disposed between the lens mount 102 and the cover member 901, and fixed to the inner circumference side of the lens mount 102 by screws or the like. The electrical contact 105 is formed by insert molding, and has a plurality of communication terminals. The plurality of communication terminals include a ground terminal and a power terminal, and is electrically connected to the ground of the lens control unit 104.

After the interchangeable lens 101 is attached to the camera body 1, the electrical contact 105 is electrically connected to the electrical contact on the camera body 1 side. An FPC 105a that is electrically connected to the plurality of communication terminals is disposed between the lens control unit 104 and the electrical contact 105. A first end of the FPC 105a is electrically connected to the lens control unit 104 via a connector (not illustrated). A second end of the FPC 105a is soldered to a plurality of communication terminals and electrically connected thereto. Thus, a communication path for various control signals, data, and the like is formed between the lens control unit 104 of the interchangeable lens 101 and the camera control unit 12 of the camera body 1.

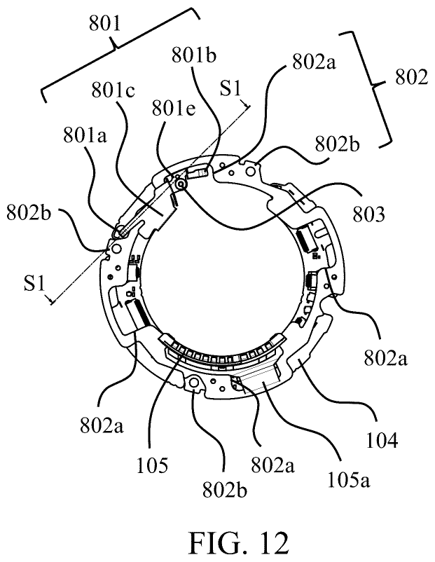

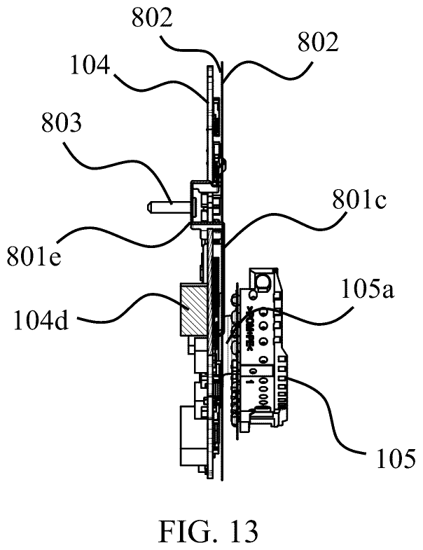

A description will now be given of the conductive member 801 with reference to FIGS. 6A to 13. FIG. 12 is a rear view of the components. FIG. 13 is a sectional view of the S1-S1 line in FIG. 12.

The conductive member 801 is made of a metal material, such as a sheet metal member such as a phosphor bronze plate, a zinc steel plate, or a stainless-steel plate. In a case where a conductive resin is used instead of a metal, it is difficult to obtain a stable conductive effect because the conductive resin itself has a high electrical resistance value.

The conductive member 801 is formed with a first elastically deformable portion 801a and a second elastically deformable portion 801b each having a leaf spring shape. The first elastically deformable portion 801a elastically contacts a ground opening (pad) provided on a flat surface on the imaging surface side of the lens control unit 104 and is conductive. The second elastically deformable portion 801b elastically contacts a flat surface on the object side of the lens mount 102 and is conductive. The conductive member 801 has a first shielding surface 801c parallel to the imaging surface so that it overlaps a connector 104b mounted on the imaging surface side of the lens control unit 104. The conductive member 801 has a second shielding surface 801d orthogonal to the first shielding surface 801c so that it overlaps the inner circumference of the lens control unit 104 in the optical axis direction.

As described above, the cover member 901 has the second notch portion 901b to avoid interference with the seventh zoom unit 117. As illustrated in FIG. 11A, at the retracted end, the seventh zoom unit 117 is retracted to a position where it overlaps the second notch portion 901b while overlapping the second shielding surface 801d in the optical axis direction, and penetrating through the first notch portion 104a. In assembling the cover member 901, the cover member 901 is inserted into the lens mount 102 from the imaging surface side and fixed to it. That is, it is difficult to position the concealing shape of the cover member 901 inside the inner diameter of the lens mount 102 while the interference with the seventh zoom unit 117 is avoided.

In this embodiment, as illustrated in FIGS. 7, 10, 11A and 11B, the first shielding surface 801c and the second shielding surface 801d are disposed in place corresponding to the second notch portion 901b. At the telephoto end illustrated in FIGS. 6B, 9 and 11B, the conductive member 801 is exposed from the opening 901a to the imaging surface side. In order to lower the reflectance of the conductive member 801 in the range exposed to the imaging surface side compared to that of the surface of the lens control unit 104, the conductive member 801 may be subjected to black plating or painting. In this case, the first elastically deformable portion 801a and the second elastically deformable portion 801b are disposed outside the opening 901a and are therefore not exposed to the imaging surface side.

In a case where the lens control unit 104 is exposed, the interior view quality lowers, but the user may inadvertently touch it. The wiring pitch of the connector 104b is reducing, and even minute foreign matter such as sebum may cause short-circuiting if it adheres to the mounted portion. The solder cracking or peeling off may occur. In order to achieve the sophisticated control function required for the recent interchangeable lens 101, the mounted area of the lens control unit 104 must be sufficiently secured.

Thus, while the seventh zoom unit 117, for example, at the telephoto end, is disposed closest to an object, the first shielding surface 801c and the second shielding surface 801d are configured to cover and hide the connector 104b so that it is not exposed from the second notch portion 901b. At this time, the first shielding surface 801c is disposed between the first notch portion 104a and the second notch portion 901b, and the second shielding surface 801d overlaps the lens control unit 104 in the optical axis direction. The first shielding surface 801c and the second shielding surface 801d do not contact the lens control unit 104.

The conductive member 801 has a fixed portion 801e. The fixed portion 801e is disposed so as to correspond to the first notch portion 104a that divides the lens control unit 104, and a first screw 803 made of a metal material is inserted into the fixed portion 801e. The exterior barrel 109 is molded from a conductive resin, and the fixed portion 801e is positioned and electrically conducted with the exterior barrel 109. The first screw 803 passes through the fixed portion 801e and the exterior barrel 109 and is engaged with the linear guide barrel 107.

As described above, the conductive member 801 is electrically conducted with the ground opening on the imaging surface side of the lens control unit 104 by the first elastically deformable portion 801a. Thus, the linear guide barrel 107, the cam barrel 108, and the exterior barrel 109 are electrically connected to the lens control unit 104 via the first screw 803 and the conductive member 801. At the same time, the conductive member 801 is electrically connected to the lens mount 102 by the second elastically deformable portion 801b.

The lens mount 102 is mechanically attached to the camera mount 7, and is electrically connected to the ground of the camera body 1. The connection of the lens mount 102 to the ground of the camera body 1 is physically more stable than the connection by the ground terminal of the electrical contact 105. That is, the conductive member 801 makes the lens mount 102, the lens control unit 104, the linear guide barrel 107, the cam barrel 108, and the exterior barrel 109 electrically conductive with each other, so that the reference potentials of the interchangeable lens 101 and the camera body 1 match more stably. Thereby, the interchangeable lens 101 can be stably controlled by suppressing the effects of static electricity and noise.

The first elastically deformable portion 801a elastically biases the lens control unit 104 toward the object side. Thereby, the lens control unit 104 can be restricted from floating up toward the imaging surface side even if warping occurs due to temperature changes or an impact occurs due to dropping or vibration.

The lens control unit 104 applies a two-phase AC voltage having a predetermined phase difference to the focus drive unit 601 through the FPC 604 illustrated in FIGS. 8 and 9. At this time, a moving direction and moving speed of the focus unit 116 can be controlled by changing the frequency and phase of the two-phase AC voltage.

A boost coil 104d illustrated in FIG. 13 is one of the electric elements mounted on the flat surface on the object side of the lens control unit 104. The boost coil 104d generates a voltage higher than the voltage supplied to the lens control unit 104 and supplies power to the focus drive unit 601. In this embodiment, the boost coil 104d has a size of 7.7 mm (D)×7.0 mm (W)×4.2 mm (H), but a larger one may be used to amplify the voltage.

The drive circuit of the focus drive unit 601 switches a DC voltage circuit using a pulse signal generated at a predetermined frequency, for example. The switched voltage is boosted by the boost coil 104d to generate a sine wave voltage to be applied to the focus drive unit 601. At this time, the boost coil 104d generates magnetic noise.

When the magnetic noise reaches the image sensor 16, a magnetic field that changes at high frequency penetrates through the signal line of the pixel charge information that extracts the image signal, and thus noise is generated in the signal line of the pixel charge information. The magnetic noise superimposed on the image signal during the process in which the image sensor 16 generates and outputs the image signal may degrade the image quality.

As described above, the conductive member 801 is made of a metal material and electrically connected to ground. The magnetic flux generated by the boost coil 104d tries to pass through the first shielding surface 801c and the second shielding surface 801d, but in a case where a change occurs in the magnetic flux density, an eddy current is generated by the electromagnetic induction. As a result, the magnetic flux penetrating through the first shielding surface 801c and the second shielding surface 801d is reduced, the effect of magnetic noise on the image sensor 16 is reduced, and the degradation of image quality is suppressed.

A description will now be given of a tilt washer (adjusting member) 802 with reference to FIGS. 3 to 5 and 7 to 13. In general, at least two tilt washers 802 are used in combination to adjust the tilt of the optical axis of the imaging optical system housed in the interchangeable lens 101. The tilt washer 802 is made of an insulating sheet material of a certain thickness, such as a PET sheet of 0.03 to 0.3 mm in thickness.

The lens control unit 104 if disposed distant from the lens mount 102 toward the object side rather than being close to it, as disclosed in Japanese Patent Laid-Open No. 2010-164872 would prevent the overall length of the interchangeable lens 101 from being reduced. Accordingly, the lens control unit 104 in this embodiment is disposed close to the object of the lens mount 102, and the tilt washers 802 are sandwiched in the space between the lens mount 102 and the lens control unit 104. The tilt washer 802 restricts the lens mount 102 and the lens control unit 104 from coming into contact. Even if the lens mount 102 and the lens control unit 104 come into contact due to an impact due to drop or vibration, short-circuiting never occurs because of the insulating property of the tilt washer 802.

Second screws 902 are fastening parts that secure the lens mount 102, and at least three screws are used. The tilt washer 802 has a thickness adjuster 802b through which the second screw 902 penetrates. Where n (n: an integer of 3 or more) is the number of the second screws 902, the thickness adjusters 802b are provided at most n−2 locations so as to be adjacent to each other. In this embodiment, the number of the second screws 902 is four, and the thickness adjusters 802b are arranged at two locations.

The tilt washer 802 can be disposed in n phases by rotating around the optical axis. That is, in a case where the number of the second screws 902 is four as in this embodiment, the tilt washers 802 can be rotated and arranged in four phases. At this time, the FPC 105a is disposed in place corresponding to one of third notch portions 802a in the phase in which the tilt washers 802 can be rotated and arranged.

At least two tilt washers 802 are arranged with a shift in rotation phase (position in the circumferential direction) and partially overlap each other. For example, in a case where the tilt washer 802 has the thickness of 0.1 mm, in a phase in which two thickness adjusters 802b overlap each other, the total thickness is 0.2 mm. Similarly, in a phase in which one thickness adjuster 802b exists, the thickness is 0.1 mm, and in a phase in which the thickness adjusters 802b do not overlap each other, the thickness is 0 mm. By combining the overlaps of the thickness adjusters 802b, a distance between the lens mount 102 and the imaging optical system increases by the thickness amount, and the desired back focus and tilt of the optical axis are properly adjusted.

In a case where the tilt washers 802 are stacked, the distance between the conductive member 801 and the lens mount 102 also increases. The second elastically deformable portion 801b is previously charged to the lens mount 102 so that the conductive member 801 and the lens mount 102 are stably electrically conducted even after adjustment by the tilt washers 802. The maximum elastically deformable amount of the second elastically deformable portion 801b is set to be larger than the adjustment amount by the tilt washer 802. This embodiment uses the tilt washer 802 to adjust the tilt of the optical axis, but may use it to adjust only the back focus.

For a fine adjustment amount by the tilt washer 802, it is conceivable that a larger number of thin sheet materials are stacked. In this embodiment, the tilt washer 802 is sandwiched between the lens control unit 104 and the first shielding surface 801c to regulate floating toward the imaging surface side. Thereby, even in a case where a plurality of tilt washers 802 are stacked, misalignment between the tilt washers 802 is unlikely to occur during assembly, and good assembly workability of components such as the lens mount 102 can be maintained.

The tilt washer 802 has four rotationally symmetrical third notch portions 802a, each of which has a smaller circumferential width than that of the first notch portion 104a. At least one phase of the third notch portions 802a is disposed in place corresponding to the second notch portion 901b. At this time, the second elastically deformable portion 801b and the fixed portion 801e are disposed in place corresponding to the third notch portion 802a.

While the disclosure has described example embodiments, it is to be understood that the disclosure is not limited to the example embodiments. The scope of the following claims is to be accorded the broadest interpretation so as to encompass all such modifications and equivalent structures and functions.

This embodiment can provide an optical apparatus that can achieve both product miniaturization and improved mounting efficiency in a structure that suppresses exposure of the mounted substrate from the notch portion in the cover member.

This application claims priority to Japanese Patent Application No. 2024-062254, which was filed on Apr. 8, 2024, and which is hereby incorporated by reference herein in its entirety.

What is claimed is:

1. An optical apparatus comprising:
a substrate having a first notch portion;
a lens mount;
a conductive member; and
a cover member having an opening and a second notch portion and fixed to the lens mount,
wherein the conductive member is disposed between the first notch portion and the second notch portion, is exposed from the opening toward an imaging surface side, and overlaps the substrate on a plane parallel to an imaging surface.

2. The optical apparatus according to claim 1, further comprising a lens unit movable along an optical axis,
wherein the lens unit overlaps the first notch portion in an optical axis direction when moved to a position closest to an imaging surface.

3. The optical apparatus according to claim 2, further comprising a guide barrel that houses the lens unit, and a first screw having electrical conductivity,
wherein the first screw penetrates through the conductive member and is engaged with the guide barrel.

4. The optical apparatus according to claim 1, wherein the conductive member overlaps a component mounted on the substrate on the plane parallel to the imaging surface.

5. The optical apparatus according to claim 1, wherein the conductive member includes a first elastically deformable portion that contacts the substrate and conducts electricity to the substrate.

6. The optical apparatus according to claim 5, wherein the first elastically deformable portion biases the substrate toward an object side, and restricts the substrate from moving toward the imaging surface side.

7. The optical apparatus according to claim 1, wherein the conductive member has a second elastically deformable portion that contacts the lens mount and conducts electricity to the lens mount.

8. The optical apparatus according to claim 1, wherein the conductive member has a first shielding surface that is parallel to the imaging surface and overlaps the substrate on the plane parallel to the imaging surface.

9. The optical apparatus according to claim 8, wherein the conductive member includes a second shielding surface that is orthogonal to the first shielding surface and overlaps an inner circumference of the substrate in an optical axis direction.

10. The optical apparatus according to claim 9, wherein the conductive member is made of a material having electrical conductivity, and
wherein each of the first shielding surface and the second shielding surface does not contact the substrate.

11. The optical apparatus according to claim 1, wherein the conductive member includes a first elastically deformable portion, a second elastically deformable portion, and a first shielding surface,
wherein the first shielding surface is disposed in place corresponding to the second notch portion and exposed to the imaging surface side, and
wherein each of the first elastically deformable portion and the second elastically deformable portion is disposed outside the opening and is not exposed to the imaging surface side.

12. The optical apparatus according to claim 1, further comprising an adjusting member that adjusts at least one of back focus and tilt of an optical axis.

13. The optical apparatus according to claim 12, wherein the conductive member includes a second elastically deformable portion that contacts the lens mount and conducts electricity to the lens mount, and
wherein a maximum elastically deformable amount of the second elastically deformable portion is larger than an adjustment amount in the optical axis direction by the adjusting member.

14. The optical apparatus according to claim 12, wherein the conductive member includes a first shielding surface that is parallel to the imaging surface and overlaps the substrate on the plane parallel to the imaging surface, and
wherein the adjusting member is disposed between the substrate and the first shielding surface.

15. The optical apparatus according to claim 12, wherein the adjusting member has an insulating property and restricts contact between the substrate and the lens mount.

16. The optical apparatus according to claim 12, further comprising at least three or more second screws that fix the lens mount,
wherein the adjusting member includes a thickness adjuster through which each second screw penetrates.

17. The optical apparatus according to claim 16, wherein where n, which is an integer equal to or greater than 3, is the number of the second screws, thickness adjusters are formed adjacent to each other at fewer than n−2 locations.

18. The optical apparatus according to claim 17, wherein the adjusting member can be disposed at n phases by rotating around the optical axis, and configured to adjust tilt of the optical axis relative to the lens mount.

19. The optical apparatus according to claim 18, wherein at least two adjusting members are arranged with a shift in rotational phase and partially overlap each other.

20. The optical apparatus according to claim 1, further comprising a barrel member having electrical conductivity,
wherein the conductive member is disposed in place corresponding to the first notch portion and has a fixed portion fixed to the barrel member.
